(19) United States
(12) Patent Application Publication
(10) Pub. No.: US 2010/0112337 A1
(43) Pub. Date: May 6, 2010

(54) Material and a method for creating a play environment

(76) Inventor: Ronald D. Coben, Houston, TX (US)

Correspondence Address: SHAPER ILER LLP, 1800 WEST LOOP SOUTH, SUITE 1450, HOUSTON, TX, 77027, US

(21) Appl. No.: 12/655,743

(22) Filed: Jan. 6, 2010

Related U.S. Application Data
(63) Continuation-in-part of application No. 12/136,699, filed on Jun. 10, 2008.
Application No. 12/136,699 is a continuation-in-part of application No. 12/291,218, filed on Nov. 7, 2008.
Application No. 12/291,218 is a continuation-in-part of application No. 12/136,699, filed on Jun. 10, 2008.

(51) Int. Cl. B32B 5/16; B05D 5/10

(52) U.S. Cl. 428/323; 156/230

(57) ABSTRACT

Material for providing a play environment for a play figure including a non-scar, quick-release adhesive roll of material having a play environment décor, and optionally including three-dimensional toy units and in particular, a roll of material for providing a rolled roadway and a method for making the rolled roadway material and microsphere adhesive with microspheres predominately oriented toward a substrate.

The instant invention is related to, claims priority to, and comprises a continuation-in-part of (1) the instant inventor's co-pending application entitled “An Apparatus and Method for a Rolled Roadway,” Ser. No. 12/136,699, inventor Ron Coben, filed Jun. 10, 2008, and (2) the instant inventor's co-pending application entitled Material and Method for Creating a Play Environment, Ser. No. 12/291,218, inventor Ronald D. Coben, filed Nov. 7, 2008. The two co-pending applications are hereby incorporated herein by reference in their entirety.

### FIELD OF THE INVENTION

The invention relates to material and method for enhancing a play environment, and particularly includes a non-scar, quick-release adhesive roll of material (or strips of material or pieces of material as defined herein) displaying a play environment structure. In particular, the invention relates to roadways, railways, runways, and other transportation surfaces (collectively defined as “roadways”) for use with toy cars, trains, airplanes and other toy and miniature transportation vehicles (collectively defined as “toy vehicles”).

### BACKGROUND OF THE INVENTION

Miniature or toy cars manufactured by HOT WHEELS™ and MATCHBOX™ and THOMAS & FRIENDS™ toy trains and die cast metal airplanes are very popular with children, even very young children. Roadways, railways and runways provided for use with such toys usually consist of multiple sections of rigid, fixed or flexible tracks with raised edges or grooves that can be assembled together to form a typically continuous roadway on which the children place the toy vehicles and pretend they are driving on the roadway. The raised edges and grooves are designed to contain the toy vehicles on the fixed tracks.

These toy vehicle roadways are often complicated puzzle pieces, requiring ownership and possession of the exact piece types and shapes need to create a specific track layout and significant time by the child or guardian to assemble the track pieces into a continuous roadway. The complexity and relatively fixed nature of these tracks means changing the track layout can be infrequent and arduous, requiring significant adult intervention and assistance. A lack of frequency in modifying these track layouts often results in less creative play with less child stimulation and resulting in more repetitive behaviors.

These fixed track systems are also limited in their portability from room to room and building to building due to the size of individual pieces and the large number of individual pieces of track required to complete a freeform, continuous roadway. The time it takes to reassemble the track pieces into a continuous roadway is also a limiting factor in transporting these track systems. For short or extended travel, many adults pack only the toy vehicles and avoid packing the more extensive, heavy and complicated track systems. If the track system is moved for travel, the roadway sections are typically housed in a dedicated container such as a large plastic bin with lid and reassembled by the parents since assembly of the track system sections can be too demanding a task for very young children. Their patience and dexterity falter in their attempt to build a roadway from multiple sections and the time required for temporary relocation and rebuilding of a roadway is perceived to be too extensive to be practical. When the trip is over, the track sections are disassembled and placed back into their container for transport to be reassembled at another destination.

Another limitation of these multi-piece track systems is the raised edges which contain the toy vehicles. The raised-edge construction makes cleaning in and around the track systems difficult and inconvenient. Dirt and dust collects on the track pieces and up against the edges of the track system pieces. The raised edges prevent cleaning using rolling vacuums and brooms. Disassembly and reassembly for purposes of cleaning is time-consuming and impractical.

Applicant has invented a cost-effective visually pleasing, child friendly system and method to create a play environment and to enhance the value of toys. The particular toy units in mind include in particular cars, trucks, airplanes and fantasy vehicles, but also may include dolls, plush toys, and/or animal and action and fantasy figures. The creation of an enhanced play environment is effected by of adhesive material (discussed more fully below,) frequently a roll of such material, displaying play environment structure and coordinated with particular toy units. Portions of the material are separated from the “roll,” including by means of easy cutting or tearing, and applied to a domestic surface, such as domestic flooring, walls, woodwork, furniture and the like. Thereby, a exciting easily positionable, environment is created for playing with cars, trucks, planes, action figures, human figures, animal figures and fantasy figures. The non-scarring quick release adhesive material can be quickly removed from the domestic substrate without damage to the substrate or residue on the substrate, and can be thrown away or possibly repositioned. Movie, video game or TV scenes can be reenacted. Popular board games can be re-created, in whole or in part, or can be expanded.

In certain embodiments, portions of the material, can contain pleated or ribbed or corrugated or spliced areas enabling the portion to be easily curved, by straightening the pleats or corrugations or connecting the spliced areas, upon application to a substrate.

The instant invention also discloses the use of pre-printed (e.g. decorated by some method) quick-release, preferably “rolls,” of adhesive material for creating, simulating and/or enhancing temporary or semi-permanent play areas, by depicting a suitable play area structure, suitable for coordination with miniature vehicles, dolls, doll houses, toy buildings, plush toys, board games or other toys. The structures depicted graphically include, but are not limited to:
décor, cabinetry, appliances, electronics, rugs, flooring, wall coverings, fashion show runway, wainscoting, signage, furniture, holiday decorations, concession stands, people, animals, crowds and other visual stimuli normally found inside a residential, commercial, industrial or recreational structure located on any known planet, moon, star or fantasy setting either in the past, present or future;
driveways, sidewalks, paths, gardens, landscaping, trees, grass, dirt, ponds, golf courses, swing sets, wood siding, brick, stone, fencing, holiday decorations, smokestacks, people, animals, crowds, vehicles and other visual stimuli normally found external to a residential, commercial, industrial or recreational structure located on any known planet, moon star or fantasy setting either in the past, present or future;
mountains, waterfalls, buildings, skylines, street lights, telephone poles, traffic lights, traffic signs, bus stops, traffic, street scenes, pets, animals, bird formations, clouds, weather, crowd scenes, people, vehicles and other visual stimuli normally found in any size rural or urban area, community, town or city located on any known planet, moon star or fantasy setting either in the past, present or future;
spaces used for movements of player tokens during the play of board games; (the order of such spaces can be random resulting in a different play of a game each time depending on where a roll of adhesive material was cut the last time, the amount of overlap and intersection used by the person applying the material to the substrate, the pattern with which the person applies the strip of material and the length of the path used by the person applying the material; thus, each occurrence of play could be very different from the prior play creating additional interest and excitement and avoiding boredom of the players;)
representation in miniature of sporting play areas and fields including but not limited to golf courses with tee-boxes, fairways and greens, bowling alleys, football fields, soccer fields, basketball courts and shuffleboard that users utilize by sliding, projecting, rolling or otherwise moving objects to simulate actual or fantasy play along a course that can be laid out differently each time by the user;
interior of castles, spaceships and fantasy structures;
scenes from movies, TV shows/DVD's and video games;
seasonal scenes, such as Santa Claus, Easter Bunny, Halloween.

The present invention in particular discloses a rolled apparatus, suitable for roadways. Also disclosed is a method for making the rolled apparatus.

### SUMMARY OF THE INVENTION

The invention is directed to material for creating a play environment for a play figure. The invention includes non-scar/quick release, adhesive material including adhesive and substrate. Portions of the material two-dimensionally simulate structures coordinated to interface with at least one three-dimensional play figure. The material includes microsphere adhesive structured for substantial adherence to, and for non-scar/quick-release from, domestic flooring, walls and furniture. The adhesive includes 10 to 80 micron microspheres with binder, the microspheres and binder applied to the substrate with the microspheres predominantly oriented to the substrate.

Preferably the microspheres have an approximately 30 micron average diameter. Preferably the material exhibits a peel adhesion of approximately 8 ounces per inch to steel after a 10 minute wet-out period. Preferably the adhesive is applied to the substrate by a transfer-coat process after which the transfer liner is removed and discarded. The one side of the substrate is release coated and the tape is self wound. Preferably the substrate includes fibrous paper, possibly with a clay coated surface as a primer. In a preferred embodiment the material is approximately 3 inches wide and wound on an approximately 1½ inch diameter core. Preferably the material includes a high performance, microsphere acrylic adhesive and comprises a roll. Preferably the substrate includes approximately 70# paper of approximately 3.5-4.2 mil thickness and the adhesive is of approximately 0.5-0.7 mil thickness.

The invention includes a method for creating a play environment for a play figure comprising transfer-coating, a high performance microsphere acrylic adhesive to a substrate to form the play material, the play material structured for easy tearing or cutting and for non-scar/quick release from domestic flooring, walls and furniture. The method includes decorating the material to two-dimensionally simulate a play environment for a three-dimensional toy.

### BRIEF DESCRIPTION OF THE DRAWINGS

A better understanding of the present invention can be obtained when the following detailed description of the preferred embodiments are considered in conjunction with the following drawings, in which:

FIG. 1 is a schematic depiction of a rolled roadway apparatus.

FIG. 2 is a schematic depiction of a rolled roadway apparatus having a roadway design on a first side;

FIG. 3 is a schematic depiction of a rolled roadway apparatus having an adhesive material on a second side.

FIG. 4 is a schematic depiction of a rolled roadway apparatus having a first section with a roadway design and a second section with icons.

FIG. 5 is a schematic depiction of a rolled roadway apparatus having a roadway design having a different color than a first side of rolled roadway.

FIG. 6 is a schematic depiction of a rolled roadway apparatus having a roadway design having a different electrical characteristic than a first side of rolled roadway.

FIG. 7 is a schematic depiction of using a rolled roadway apparatus for a miniature car and icons on a surface.

FIG. 8 is a schematic depiction of a rolled roadway apparatus having an adhesive and icons applied to the same side of the rolled roadway apparatus.

FIG. 9 is a schematic depiction of a rolled roadway apparatus deployed on first surface and icons deployed on a second surface oriented 90 degrees with respect to the first surface.

FIG. 10 illustrates aspects of the adhesive of the present invention.

FIGS. 11A-11G illustrate multiple forms in which a “roll” of the instant “material” might be provided, which could be similar to a roll of tape, a roll of wallpaper, a box of tissues, a packet of wipes, a canister of wipes and/or a stack of post-it sheets, all of which are methods of presenting sequenced portions of material and are referred to herein as a “roll.”

FIGS. 12A-12D illustrate sheet shaped portions of roll material adhered in a room, on a wall, and on a floor, to create a play environment.

FIGS. 13A-13C illustrate how portions of material with adhesive along one edge can create a freestanding play area either alone or in conjunction with other materials affixed to floors, walls or other toys, as stand-up portions, and how said portions can curve.

FIGS. 14A-14H illustrate examples of removable “roadway” related tape.

The drawings are primarily illustrative. It would be understood that structure may have been simplified and details omitted in order to convey certain aspects of the invention. Scale may be sacrificed to clarity.

### DETAILED DESCRIPTION OF THE PREFERRED EMBODIMENTS

The present disclosure presents, in one embodiment, illustrative sets of roadways, railways, runways, and other transportation surfaces (collectively defined as “roadways”) for use with toy cars, trains, airplanes and other toy and miniature transportation vehicles (collectively defined as “toy vehicles”). In a particular embodiment, a rolled roadway, which in a preferred embodiment may be a laminate, is disclosed that is easily transported between locations to form a roadway and associated structures to simulate a city environment with houses, trees, churches and people, etc. In another particular embodiment, the roadway is formed on a substrate such as paper, upon which an adhesive is applied to a first side and a printed material representing a roadway placed on a second side. The roadway substrate is coiled or rolled onto a cylinder such as a tape spool for easy dispensation of additional roadway as needed. A preferred roll is 3 inches wide, wound on a 1-3 inch, preferably a 1.5 inch, core. In another embodiment, the substrate is a clear or substantially transparent medium such as a paper or a polymer upon which an adhesive and printed matter are placed on the same side of the substrate representing a roadway. The roadway adhesive is adhered to a floor or other surface and the design is seen throughout the transparent substrate. The transparent substrate also protects the printed roadway from being scratched by toy cars during use on the roadway. In another illustrative embodiment, an easily scuffed paint is placed on one side of the substrate and an adhesive on the other side. Thus, when the toy cars traverse the roadway, a child can make skid marks with the toy car or vehicle by scuffing the easily scuffed paint on the roadway. Microcapsules can be placed on one side of the roadway and an adhesive on the other side, so that a child can make scuff or skid marks on the roadway by bursting microcapsules filled with ink on the roadway. In another illustrative embodiment, a thermo chromic paint is placed on the roadway side of the substrate so that an ice cube rubbed on the roadway chills the thermo chromic paint, changing the temperature of the thermo chromic paint such that the thermo chromic paint turns the roadway a different color to manifest the appearance of hazardous conditions on the roadway, at least until the thermo chromic paint returns to room temperature after being chilled by the ice cube.

In a particular embodiment, the rolled roadway can be made from a road design including a roadway background and striped centerline running down the center of the roadway placed on a roll of tape or the like. Preferably the road way is about 3 inches wide and portrays a two-way traffic. The roadway is easily applied to a floor, carpet, tape or other surface area to form a roadway for the miniature cars. When the children are through playing with the cars, the roadway can be removed from the carpet, tabletop or floor and be discarded. The next roadway can be unrolled from the rolled laminate or roll of tape. Thus, no disassembly is required. Alternately the roadway can be removed and reused.

Assembly is also easy so that a very young child can unroll the rolled tape roadway and place the sticky side of the tape to a carpet or floor to make a roadway visible and accessible on the non-sticky side of the tape. The rolled tape or laminate also contains associated structural designs such as houses, trees, churches and people, etc. The associated structures are placed on the surface area adjacent the roadway to simulate a city environment with houses, trees, churches and people, etc. through which the roadway traverses. In another embodiment, the substrate is easily torn so that a child can tear off as much roadway and/or structural icons as the child wants to form the roadway and structural representation of a city along the roadway.

In regard to the present disclosure that relates to the field of roadways, railways, runways, and other transportation surfaces (collectively defined as “roadways”) for use with toy cars, trains, airplanes and other toy and miniature transportation vehicles (collectively defined as “toy vehicles,”) a center line is typically placed on the roadway for a street upon which cars travel in two ways. In another particular embodiment, a center line for an airport runway is placed on the roadway for a runway upon which toy airplanes travel. In another particular embodiment, a rolled roadway is disclosed having a lines placed on the roadway for a rail road track upon which toy trains travel.

In another particular embodiment, an apparatus is disclosed including but not limited to a rolled tape having a first side and a second side. A first design material indicating a road center line is placed in the center and along the longitudinal axis on the first side of the rolled tape. A second design material including but not limited to a tacky material placed on the second side of the laminate. In another embodiment of the apparatus the tape is a laminate and the first design is a laminate.

In another embodiment of the apparatus the first side of the substrate, which can be a laminate, paper, polymer or other suitable material, has a first color and the design has a second color. In another particular embodiment, a plurality of colors are provided for a first color and a second color for use in the present invention. In another particular embodiment, a plurality of colors are used for the roadway, road way center line and the design so that more than 2 colors appear on the rolled roadway and roadway center line. In another particular embodiment, a center line is place on the roadway for a street upon which cars travel is disclosed. In another embodiment of the apparatus the first side of the substrate has a first texture and the first design has a second texture. In another embodiment of the apparatus the first side of the substrate further includes but is not limited to a first section and a second section wherein the first design material is applied to the first section and second design material is applied to the second section, the second design material indicating a town structure icon selected from the group consisting of a house, church, tree, road way sign and person.

In another embodiment of the apparatus the first design material has a different electrical characteristic than the first side of substrate. In another embodiment, a method is disclosed, the method including but not limited to forming a rolled substrate by contacting a first side of the substrate with a second side of the tape; placing a first design on the first side of the substrate, wherein the first design indicates a roadway centerline placed on the first side of the substrate; and placing a tacky material on the second side of the substrate. In another embodiment of the method, the substrate is a laminate and the first side of the substrate has a first color and the first design has a second color.

In another embodiment of the method the first side of the substrate has a first texture and the first design has a second texture. In another embodiment of the method the first side of the substrate further includes but is not limited to a first section and a second section wherein the first design material is applied to the first section and a second design material indicating a town structure icon selected from the group consisting of a house, church, tree, road way sign and person. In another embodiment of the method the first design material has a different electrical characteristic than the first side of substrate.

In another embodiment, a method for using a rolled substrate is disclosed, the method including but not limited to attaching the rolled substrate, the substrate having a first side and a second side, wherein the first side further includes but is not limited to a design material placed on the first side, the first design material indicating a road center line and the second side further includes but is not limited to a tacky material placed on the second side of the substrate, by applying the tacky material on the second side to a surface area to form a roadway having the road center line in the center of the road way.

In another embodiment of the method the first side of the substrate has a first color and the first design material has a second color. In another embodiment of the method, the first side of the substrate has a first texture and the first design material has a second texture. In another embodiment of the method the first side of the substrate further includes but is not limited to a first section and a second section wherein the first design material is applied to the first section and a second design material indicating a town structure icon selected from the group consisting of a house, church, tree, roadway sign and person is applied to the section. In another embodiment of the method the first design material has a different electrical characteristic than the first side of the substrate.

In another embodiment, an apparatus is disclosed including but not limited to a rolled substrate having a first side and a second side; a first material indicating a road center line placed on the first side of the substrate; and a second material including but not limited to a tacky material placed on the second side of the laminate. In another embodiment of the apparatus the first side of the substrate has a first color and the first design has a second color. In another embodiment of the apparatus the first side of the substrate has a first texture and the first design material has a second texture. In another embodiment of the apparatus the first side of the substrate further includes but is not limited to a first section and a second section wherein the first design material is applied to the first section and a second design material indicating a town structure icon selected from the group consisting of a house, church, tree, road way sign and person is placed on the second section of the tape.

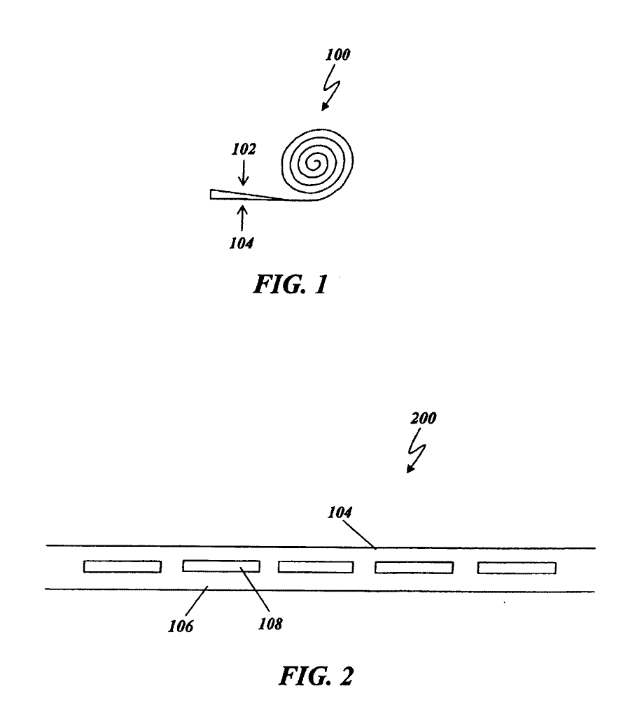

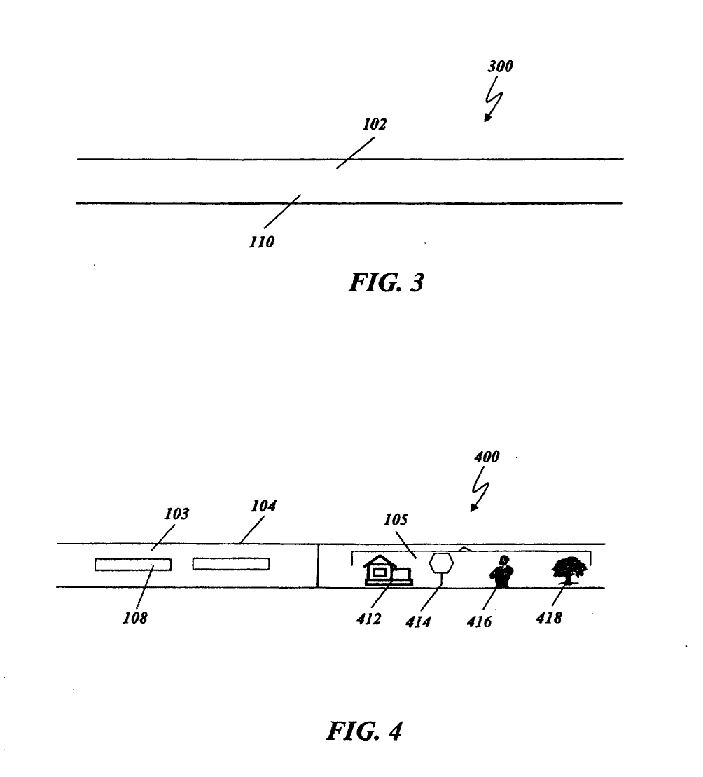

As shown in FIG. 1, an apparatus 100 is depicted including but not limited to a rolled substrate. In a particular embodiment the substrate is a tape. In another particular embodiment, the substrate is a laminate. In another particular embodiment, the substrate is any suitable material for use as a roadway as disclosed herein. In a particular embodiment, the substrate has a first side 104 and a second side 102. In a particular embodiment, when applied to a surface such as the floor, carpet or a table top, the second side touches and adheres to the surface and the first side faces away from the surface and forms the roadway surface upon which the vehicles traverse the roadway surface. As shown in FIG. 2, a first design material 108, printed material or laminate indicating a roadway center line 108 is placed on the first side 104 of the substrate, tape or laminate 106. The substrate 106 has a first color and/or electrical characteristics. In another particular embodiment the roadway center line is printed onto the substrate forming the rolled road way. As shown in FIG. 3 a material, or laminae 110 including but not limited to a tacky or adhesive material is placed on the second side 102 of the laminate, polymer, paper, substrate or tape. The adhesive material causes the second side of the substrate to adhere to the surface upon which it is placed.

Turning now to FIG. 4, in another embodiment of the apparatus the first side 104 of the substrate, polymer, paper, laminate or tape further includes but is not limited to a first section 103 and a second section having icons 105 wherein the first design material, printed material or laminae 108 is applied to the first section 103 and a second design material or laminae having icons 105 is placed on the second section, the second design material indicating a town structure icon selected from the group consisting of a structure icon such as a house 412, a tree 418, a road way sign 414 and a person 416. In another embodiment of the apparatus, the first laminae or printed material 108 has a different electrical characteristic than the tape, substrate or laminate 106. The different electrical characteristics enable an electromagnetic sensor on a toy vehicle to sense the electrical characteristic of the first laminae which represents a road way center line, thus enabling the toy vehicle to sense when it is proximate the road way center line while traversing the road way. In a particular embodiment, the toy vehicle is equipped with a beeper that sounds when the toy vehicle strays from a path proximate the road way center line.

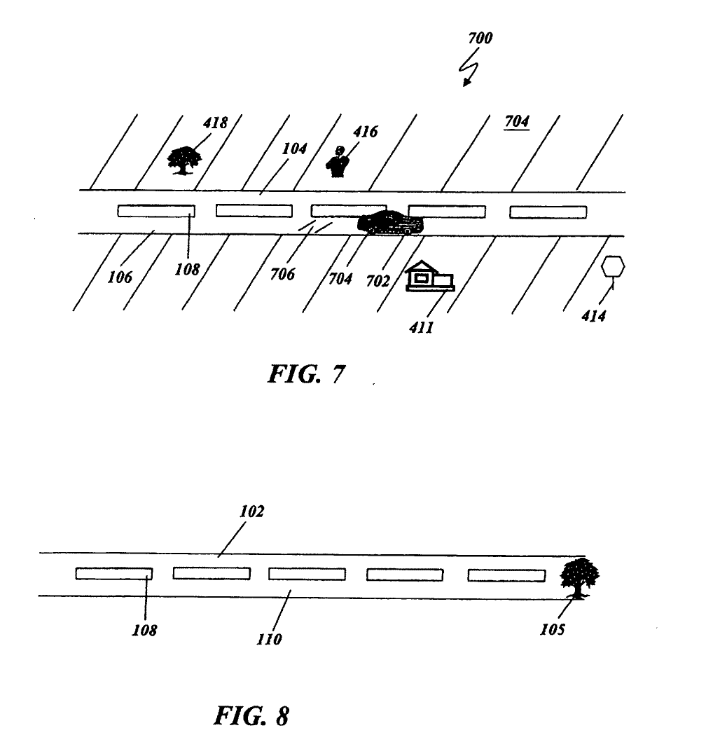

In another particular embodiment, the toy vehicle is self propelled with an auto guidance system that allows the toy vehicle 702 (shown in FIG. 7) to sense the roadway center line and follow the roadway by staying on a path proximate the roadway center line. In another particular embodiment, the roadway center line of first design material 108 is a different color than the substrate 106 and the toy vehicle is equipped with a sensor that enables an electromagnetic sensor on a toy vehicle to sense the different color of the first laminae or printed material which represents a road way center line, thus enabling they toy vehicle to sense when it is proximate the road way center line while traversing the road way.

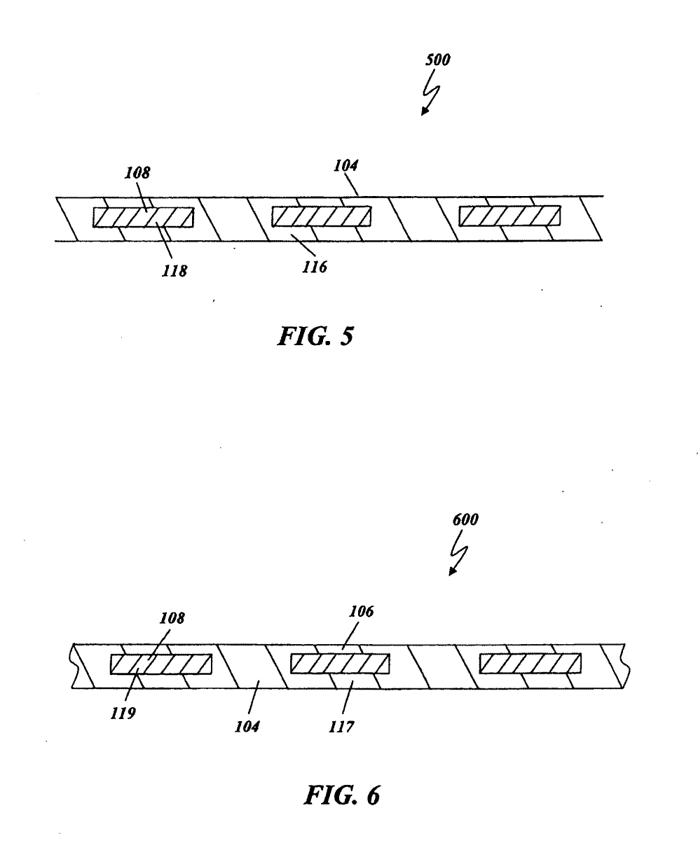

Turning now to FIG. 5, in another embodiment of the apparatus, the first side 104 of the tape, substrate or laminae has a first color 116 and the first design or laminae 108 has a second color 118. In a particular embodiment, the toy vehicle is equipped with a beeper 704 that sounds when the toy vehicle strays from a path proximate the road way center line 108. In a particular embodiment, the toy vehicle is self propelled with an auto guidance system that allows the toy vehicle to sense the roadway center line and follow the roadway by staying on a path proximate the roadway center line. Turning now to FIG. 6, in another embodiment of the apparatus, the first side of the laminate or tape 104 has a first texture 117 and the first design material or laminae 108 has a second texture 119. Turning now to FIG. 7, in another embodiment, the rolled laminae is a rolled tape with a first design material side 104 and second tacky adhesive side 102. The tacky side of the rolled laminate or tape is unrolled and adhered to a surface 704 to form a roadway on the surface 704. A toy car 702 can be guided along the road way 106 by a child for entertainment. The icons 418, 416, 411 and 414 are placed on surface 704 adjacent the roadway formed by adhering the rolled tape to the surface. In another particular embodiment, an easily scuffed material is applied to substrate second side 104 so that when a child's hand applies extra pressure to the toy vehicle, scuff marks 706 are left on the roadway substrate with paint or colored liquid filled microcapsules are?

As shown in FIG. 8, in another particular embodiment, the substrate is transparent and the adhesive 110 and printed roadway 108 and icons 105 are placed on the same side of the substrate 102. Thus, when the second side 102 is adhered to a surface, the printed material 108 can be seen through the substantially transparent substrate. Printing the materials on the adhesive side contacting the surface prevents scratching of the printed material during traversal with a toy vehicle 702.

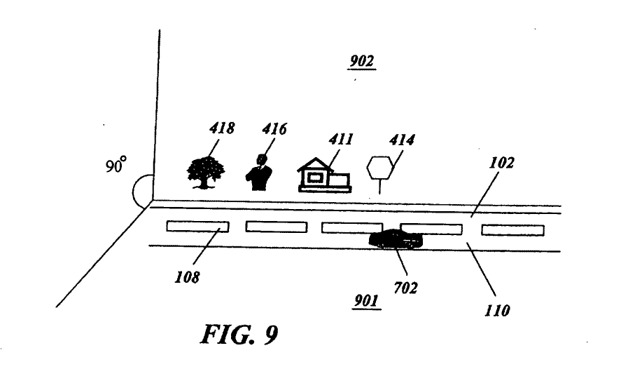

As shown in FIG. 9, in another particular embodiment, the roadway 108 is applied to a first surface 901 having a different orientation than, for example, 90 degrees, relative to a second surface 902 upon which the structural icons 105 are applied.

FIG. 10 illustrates a transfer coated microsphere adhesive oriented to a substrate. Substrate TS illustrates a substrate such as a tape. MS illustrates microspheres in the adhesive and element BA illustrates binder adhesive connecting microspheres. Release liner RL is utilized to transfer microspheres and binder adhesive to the substrate. FIG. 10 illustrates that the microspheres are oriented toward the substrate after the transfer, in the sense that a greater portion of the microsphere faces the substrate than the release liner or subsequent environment upon removal of the liner.

Illustrative play environment structure can include a roadway, a parking way, a waterway, a plane runway, a fashion model runway, a fence, an interior structural wall or area with related units, an exterior wall or structure with related units, a scenic view, a farm yard, a sports field, a mall, a parking lot, a school field, a play field, a mythical space or structure, a battlefield, the interior of a spaceship and the exterior of a spaceship.

A related play environment unit or figure or toy can include a car, a truck, a boat, a plane, a doll, an action figure, a hero figure, a human figure, an animal figure, a mythical figure, a movie or TV figure or a board game marker.

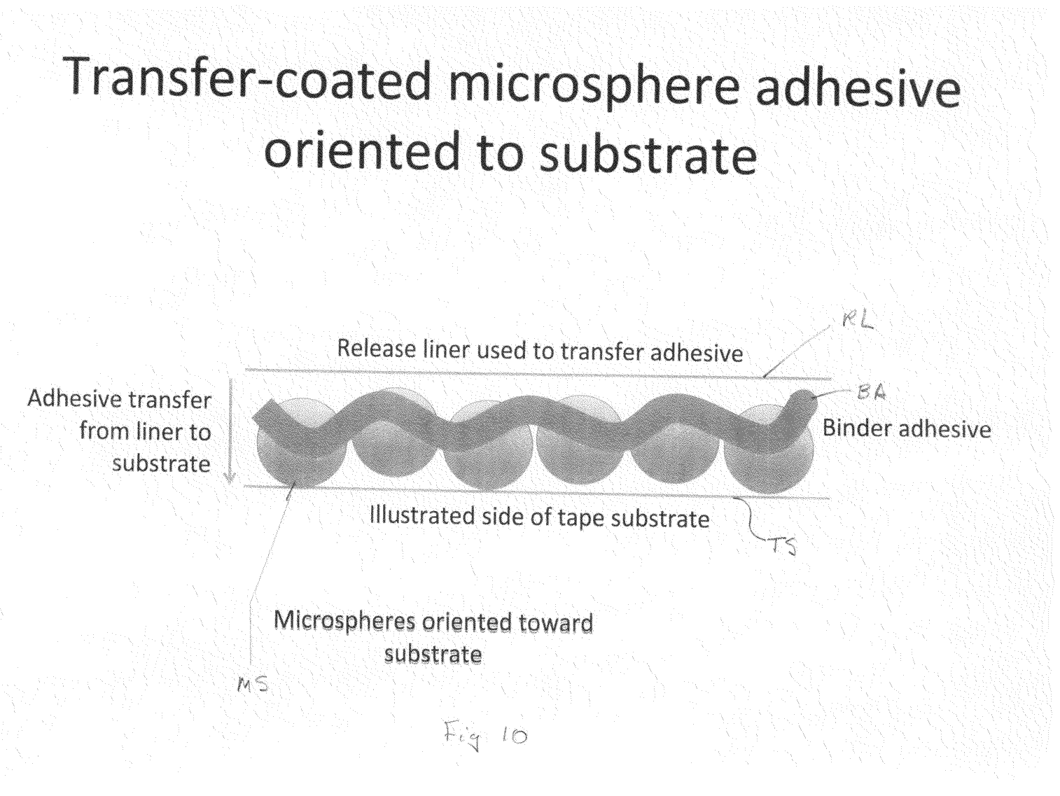

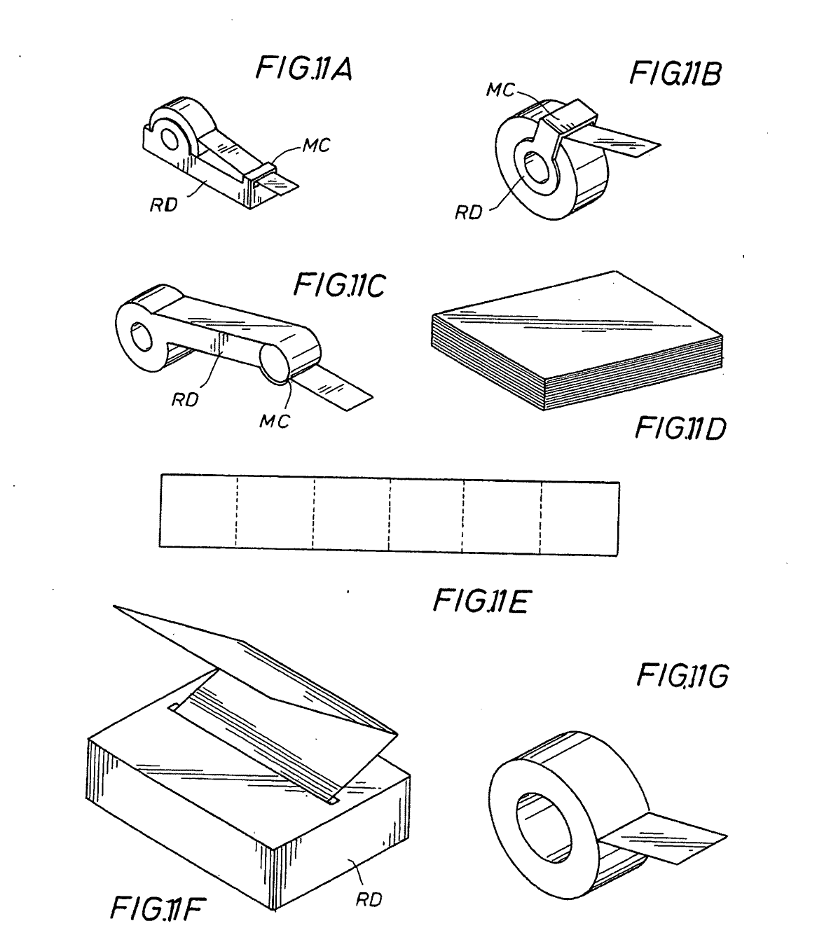

In preferred embodiments a roll of material may also include a roll container or dispenser and means for cutting or tearing the roll of material, or for separating portions of the roll. FIGS. 11A-11F illustrate roll containers or dispensers RD and means for cutting or separating out portions of roll material, MC.

In preferred embodiments a “roll of material” might resemble a roll of tape, including a wide roll of tape. However, separate or loosely attached sheets might be folded, interleaved or rolled together to form a “roll of material.” A “roll of material” should be understood to include a length of material folded again back on itself. Tissue in a tissue box or wipes in a wipe package or a roll of stamps are intended to be regarded as a roll of material. The roll of material could take the form of a pad of post-it notes which could be removed in sequence. The understanding would be, again, that the pad of sheets would have adhesive applied such that the sheet would substantially adhere to a substrate. See FIGS. 11A-11G. FIG. 11G represents a roll of material or tape without any cutting device on tape.

Play environment units could also include a minimally 3D set of stickers that are removed from a substrate and utilized in combination with a suitable play environment décor, especially when simulating a movie or video game or TV scenario.

The non-scar and quick-release features of the adhesive are important to ensure that the material may be easily removed from floors, woodwork, table tops carpets, fabrics, concrete and other domestic substances without scar, mar, stain or residue.

The adhesive can be applied to the roll solidly or could be applied in stripes, dots, cross-hatching or crisscrossing. The essential feature of the adhesive is that a roll portion substantially adheres to a floor or wall or tabletop, including in particular at one or more edges and corners, to facilitate trouble-free use, as it is designed for use.

Preferably the adhesive is a solvent-based, removable, pressure sensitive adhesive (such as an “acrylic”) which has a low peel value (defined as the number of ounces per inch required to break the adhesive bond).

Selecting the proper adhesive and substrate is important to the invention. The substrate must not only provide for a stable, durable two-dimensional display of a play environment, such as a roadway and the like, but must also provide for easy cutting or tearing by children. The adhesive must provide for suitable adhesion to, as well as non-scar, quick release from, domestic flooring, walls and furniture. Preferably the adhesive provides for repositioning.

An adhesive and substrate were developed in combination in the instant invention. The preferred substrate is a fiber substrate, a paper, preferably a 70# paper which is 3.5-4.2 mil thick. The substrate may receive a clay coated surface as a primer to enhance the adherence of the adhesive. Other priming means, such as an etching treatment, are also known.

The preferred adhesive is a high performance microsphere acrylic adhesive designed to achieve suitable adhesion as well as consistent clean removability over time. It was found, for instance, in testing, that a non-microsphere emulsion based acrylic adhesive, a “binder type” adhesive, would suitably remove after a short period of time but became harder to remove over time, eventually leaving a residue or becoming difficult to completely remove. It was further determined, in testing, that a microsphere adhesive that was not transfer-coated did not adhere acceptably to domestic carpeting. It was determined, by testing, that a preferred and superior adhesive is a microsphere adhesive transfer-coated to a fibrous paper substrate such that the microspheres are “oriented toward the substrate.”

As understood by those of skill in the art, with microsphere adhesive, microspheres form a slurry within a binder and solvent. In a direct-coat process the microspheres are “oriented” toward the outside, away from the substrate upon which they are coated. In a transfer-coat process, where the adhesive is first coated on a liner and then the liner is applied to the substrate, the microspheres are “oriented” toward the substrate. It was determined, by testing, that a transfer-coated microsphere adhesive met the performance requirements for the invention and offered a superior adhesive. The preferred process for creating the material is to transfer-coat the adhesive to the substrate, thereby orienting the microspheres toward the substrate.

Basically, adhesives are mixtures of polymers and solvents (including water) and catalysts. Sometimes there are dye or fillers are added to achieve color or other properties. The adhesive mixture is typically pumped into a coating head which dispenses the mixture directly onto either a substrate (direct-coating) or a release liner (transfer-coating.) The adhesive then goes under a roller or doctor blade or the like to control the thickness of the adhesive on the substrate or liner. The product is then pulled through an oven system that cures the adhesive by drying off the solvent. Different adhesive systems are cured at different temperatures. If the adhesive is direct-coated onto a substrate the adhesive curing process may be sufficient to anchor the adhesive to the substrate. Alternately, a primer may be used to improve anchorage, like a clay coating on paper, or an etched treatment on films. The primer prepares the surface of the substrate for the adhesive.

When an adhesive is coated onto a release liner, such as the silicon coated liner, and then the adhesive is pressed or laminated against a non-release coated surface, the adhesive transfers from the release coated liner surface onto the non-coated surface. The application of heat and pressure during the lamination or transfer may speed up the process and increase the bonding of the adhesives.

When the liner used in the instant transfer-coat process is removed, testing shows that the transfer-coated adhesive, bonding onto the substrate to form the material, forms a superior self-wound product with the liner removed. The instant inventive product has a need to stick to both smooth and rough domestic surfaces. It has been found, through testing, that the transfer-coat process with the microspheres oriented toward the substrate forms a superior product for its applications.

In regard to the substrate, it has been found that the smoother the paper surface the better the anchorage. A clay coated surface provides a smooth clean surface that is preferable for bonding with the adhesive. Clay coating may be used as a primer to increase adhesion to the substrate.

The preferred thickness of the material is between 4-5 mils. In that thickness the substrate comprises approximately 3.5-4.2 mil thick paper and the microsphere adhesive is approximately 0.5-0.7 mils thick. The microsphere is preferably of average diameter of 10 microns to 80 microns. A preferred microsphere diameter is approximately 30 microns. The preferred peel adhesion is approximately 8 ounces per inch to steel after a 10 minute wet-out period.

Testing indicated that with spray coating or direct-coating of the adhesive to the substrate, the level of adhesion to domestic surfaces was less than with the transfer-coat process, and the adhesive did not properly stick to domestic carpeting. The microspheres were not oriented toward the substrate, which was determined to be the desirable orientation of the microspheres.

During the pendency of Applicant's above two referenced applications, applicant discovered the existence of a “Autobahn tape” product. The instant inventor purchased the tape, tested the tape and offers the following observations. First, the Autobahn tape substrate is a significantly thinner, polypropylene material rather than paper. It cannot be torn from the roll by hand, requiring the tape to be punctured or cut with a sharp tool. Secondly, the Autobahn tape, according to testing, does not utilize microsphere adhesive. The tape material does not appear to receive its adhesive by the methodology of transfer-coating.

After the adhesive is applied to the material, the material may be self-wound or stacked or folded into a “roll”. The material with adhesive and printed graphics of structure is preferably wound onto a core. Users then can simply pull the free end of the substrate and the material preferably releases from itself and is ready to stick on another surface. The non-adhesive portion of the material may be treated with what is commonly called a “release coat” so that the material more easily releases from itself and unwinds.

“Stickers” are pressure sensitive adhesives affixed to a liner. A consumer peels a sticker from the surface of a liner. It is possible to self-wind stickers on liners in which case no release coat would be needed but the liner is left behind to be discarded. Preferably the instant material is self-wound on a core without a liner so that it appears and functions as a typical roll of tape. In a less preferred embodiment the material is self wound as tape on a liner.

Options for dispensing include no dispenser, because the product may be used directly by children. Preferably the product is designed to be suitably thin and of a material that can be easily hand torn or cut by child or adult scissors.

The product may also have perforations running the width of the tape at various intervals along the roll to facilitate straighter hand-tearing. The product may come with an un-honed, non-serrated straight-edge which affixes to the roll and sits along the outermost surface of the roll to provide a non-sharp edge upon which the tape may be torn straight.

The product may provide a dispenser which holds the core of the roll allowing it to freely spin and provides a serrated cutting edge to cut the tape and a small surface with which to adhere the leading edge of the tape away from the roll itself thereby making it ready for the next use.

The product may provide a hand-held applicator/dispenser which holds the leading edge of the material away from the roll itself and exposes some or all of the leading edge whereby it can be touched and adhered directly to a surface, freely rolled, and cut with a straight-edge or serrated edge on the “gun” all with one hand movement. The product could also be applied and cut using a dispenser disguised to look like a hand-rolling toy vehicle which dispenses product as the wheels of the toy-dispenser rotate.

A container or supporting device without sides or with limited sides could hold a stack or pad of pre-cut lengths of product that can be peeled off one at a time. This embodiment works best if the entire back of the tape is not coated with adhesive but if adhesive is on one-edge of the material.

A container with an opening on the top surface which holds pre-cut lengths of the product stacked accordion style to allow quick, “pop-up” access may be provided. This embodiment works best if the entire back of the tape is not coated with adhesive, but if adhesive is on only one edge of the substrate.

### Product Variations

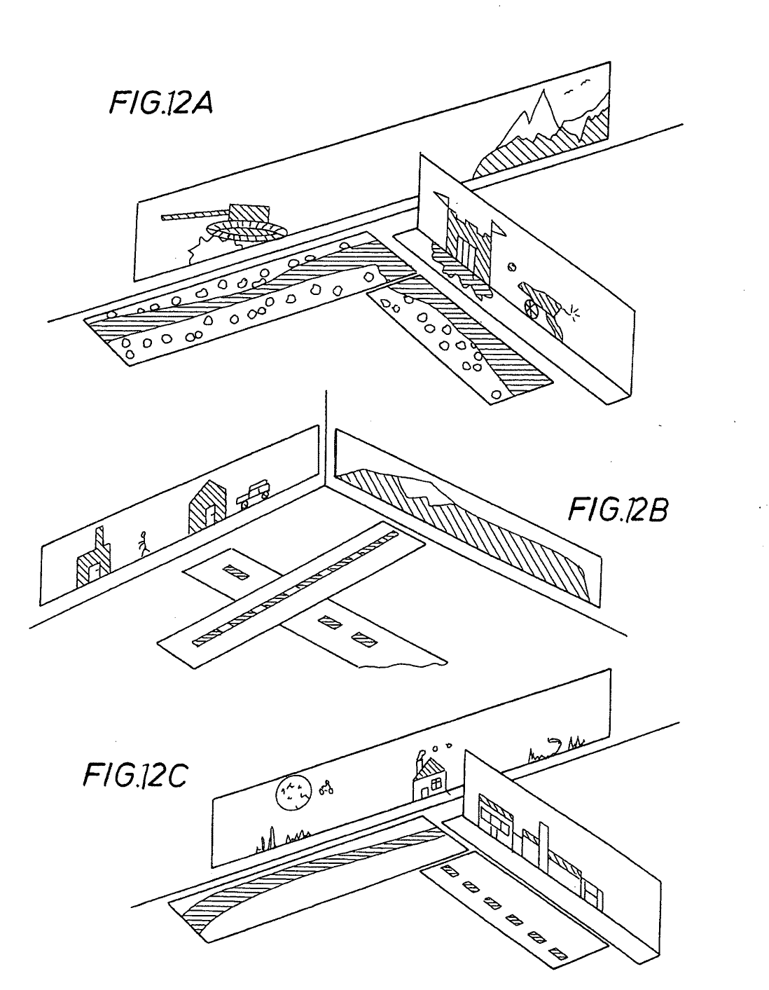

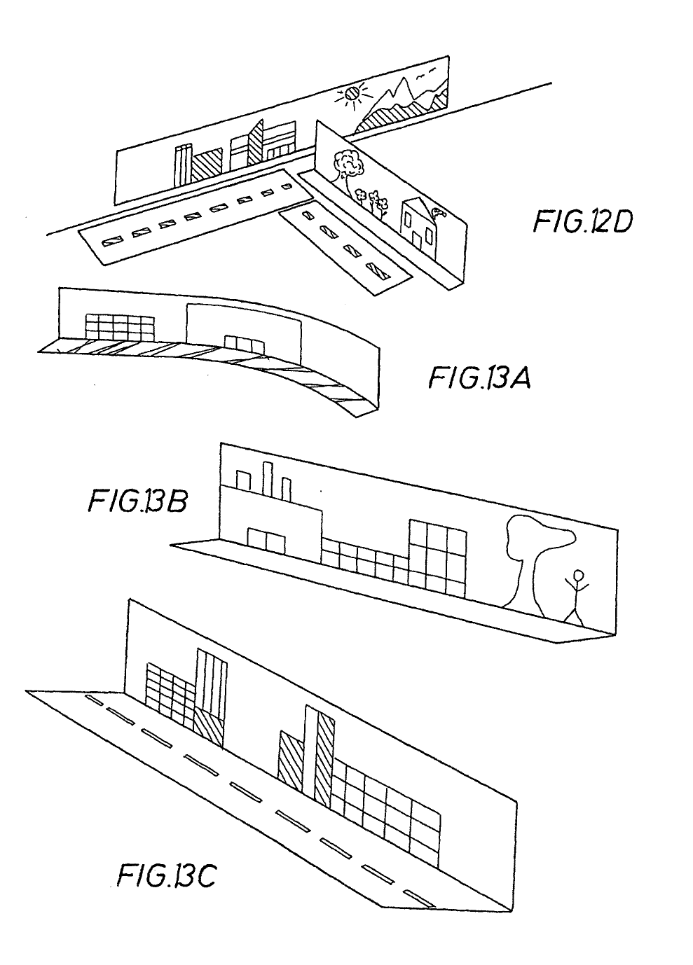

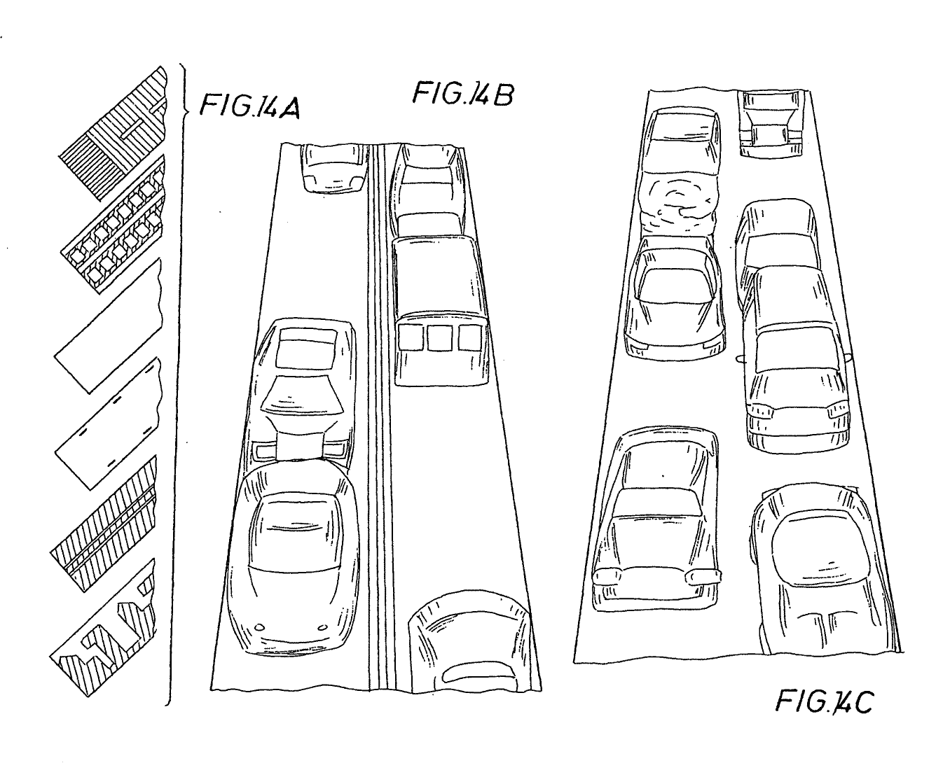

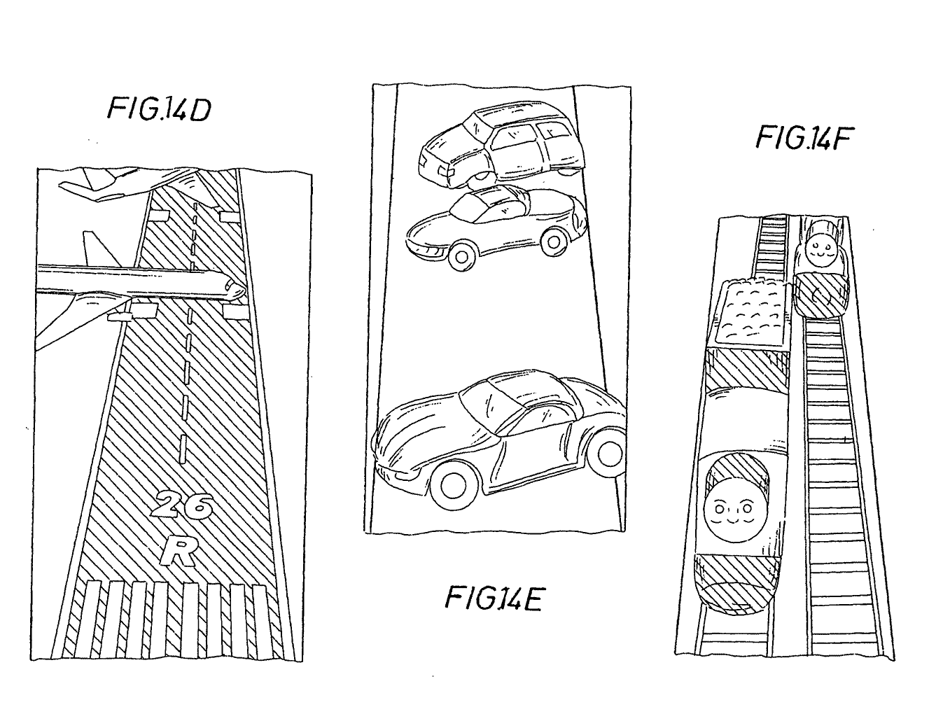

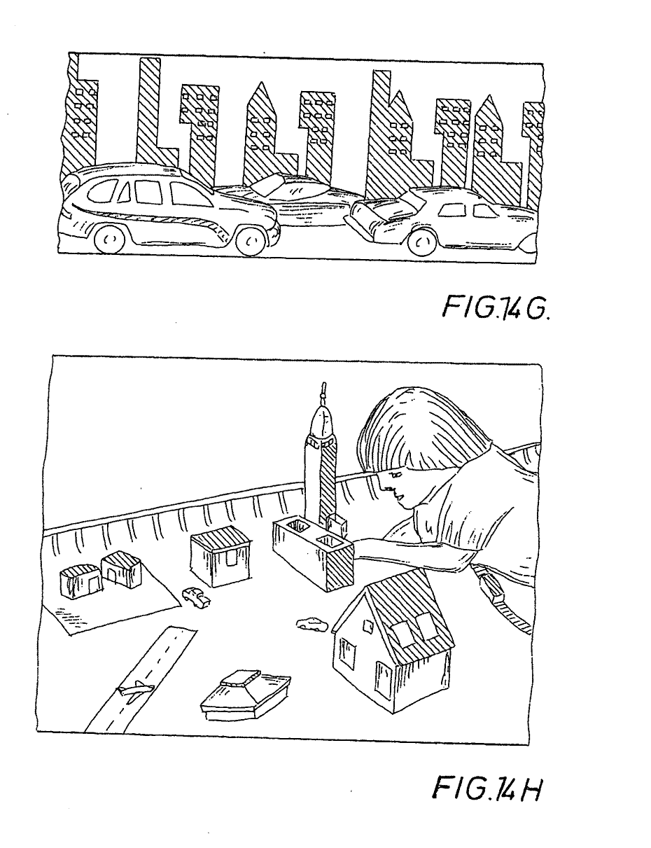

FIGS. 12A-D and 13A-13C illustrate stand-up scenery/structures/figures/thing. A material with adhesive along one edge or side and no adhesive along the other edge or side can be provided such that when a length of the tape is torn, cut or perforated from the roll, the adhesive edge is placed on a surface and the tape may be creased to create an approximate right angle. The non-adhesive portion of the tape preferably stands at an approximate 90 degree angle from either a horizontal or vertical surface creating a three-dimensional play surface or accessory from an otherwise flat piece of tape. Example structures include: scale versions of skylines, storefronts, cityscapes, structures (four pieces placed at right angles create a four-sided building), people, characters, animals, patterns, etc. This style of product in short lengths lends itself to the pop-up style dispenser, for example, a pop-up box of building sides to create buildings of various polygonal shapes, a pop-up box of street signs, a pop-up box (perhaps the size of a roll of Saran Wrap) of street scenes or skylines, etc.

FIG. 13A illustrates a curved stand-up scenery/structures/figures/thing, which is the same as above except the edge of the tape with the adhesive has partial cuts (or perforations that can be torn or corrugation that can be smoothed out) which allows a user to slightly overlap the adhesive pieces as they are adhered to the surface creating a curved substrate which stands up approximately perpendicular to the base surface. FIG. 13C gives an illustration of how freestanding scenery could also be printed on the edge which is adhered to the substrate. In the attached drawing, a roadway is printed on the surface of the edge with adhesive and a skyline on the edge which is folded upright. Tape or material can be creased or scored to facilitate bending.

Die-cut accessory pieces can be included with the invention. Utilizing the same adhesive, one can create die-cut accessory pieces on liners to be peeled off and used in conjunction with the core product offering and to facilitate connections, directional changes, areas of interest, etc. Examples include: intersections, roundabouts, curves, etc.

Use of special inks on the printed side of the material or in combination with printing on both sides of the material tape allows for the graphic representation of one scene or object which then changes when the light source in the room changes. For example, a tape printed with blue sky, clouds and the sun would disappear when the lights in the room are turned off and a glow-in-the-dark night sky, moon, and stars would appear. Or a sunny, daytime skyscraper skyline would have yellow windows, red airplane warning lights and a moon appear when room lights are dimmed.

Use of a draw your own tape is envisioned. This includes an uncoated, writable substrate that allows users to create their own scenes, characters, vignettes, objects, etc. and position their own art or creations within their work or play area.

Tables 1 and 2 summarize facts related to, and illustrate the present need for, the invention. Table 3 illustrates criteria for the invention, and objectives. Table 4 lists benefits of the invention.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

THE NEED

```
Boys love toy vehicles
    94% of boys age 3-9 regularly play with toy vehicles including
    Hot Wheels ®, Matchbox ®, Thomas the Tank Engine ®,
    and diecast airplanes
    Mattel reports Hot Wheels ® & Matchbox ® domestic revenue of
    $250-$300 million plus $600-$700 million more internationally
Boys prefer “hand-rolling” toy vehicles to “propelling” vehicles
    57% usually hand-roll vs. 42% usually propel the vehicles
Tracks/sets/kits under-penetrate boys who play with toy vehicles
    89% own Hot Wheels ® vehicles; only 49% own Hot Wheels ®
    track & sets
    69% own Matchbox ® vehicles; only 25% own Matchbox ®
    tracks & sets
    54% own Thomas ® trains; only 33% own Thomas ® track
    43% own toy airplanes; only 9% own runways or airports
    53% own a cityscape play mat
```

Nationwide Study Proves
Road Play ™ Popularity Rivals
Hot Wheels ®, Lego ® & Matchbox ®

```
In a nationwide survey of parents whose children age 3-9 play with toy
vehicles during most of their playtime, 75% stated they would buy Road
Play ™ once the product is brought to market (19% of the respondents
“might” buy; only 6% said they would “not buy” it). These parents
indicated they would buy nearly four rolls of Road Play ™ annually. 71%
viewed the $7.99 price point as “about right;” four in ten respondents
would be willing to pay more than $7.99 with 23% willing to pay up to
$10.99. Impressively, the survey also showed toy ownership patterns for
these same families and how Road Play's purchase intent would compare:
    90% own Hot Wheels ® vehicles
    75% stated they would buy Road Play ™
    73% own Lego ®
    73% own Matchbox ® vehicles
    62% own Thomas the Tank Engine ® trains
    58% own toy airplanes
    56% own Hot Wheels ® track or sets
    52% own a cityscape rug
    44% own Thomas the Tank Engine ® wooden track
    35% own a raised play table
    31% own Matchbox ® track or sets
Result: Purchase Intent for Road Play ™ rivals purchase behavior for Hot
Wheels ® , Lego ®, Matchbox ®, & Thomas the Tank Engine ®
vehicles, tracks, & sets.
```

THE CRITERIA

```
Kid and parent-friendly
    Quick to use and requires little to no assembly
Infinitely flexible
    Highly engaging to the child and promotes creative expression
Realistic
    Allows the child to replicate their world
Inexpensive
    Price-point encourages frequent repeat purchases
Inclusive
    Easily integrates with most major brands of toy cars & building sets
Floor-friendly
    Use on most surfaces without fear of damage
Obvious fit
    Instantly leverages the established toy vehicle market & allows for
    easy display at mass market retailers and specialty toy stores
```

PRODUCT BENEFITS

```
Instant fun
    Quick and easy to use by adults or children
    Corner connections are instantaneous and foolproof
    Travels anywhere the child goes
    Light, small and easy to carry
    Converts hard-to-roll surfaces into smooth rolling roadways
    Strong graphic appeal has no language barriers
Flexible
    Can be as temporary or semi-permanent as desired
    Allows for frequent changes to any play area
    Can be used anywhere: floors, low-pile carpet, hallways, tabletops,
    highchair trays, grandparent's house, restaurants, businesses
    Works in any size space; is infinitely adaptable
Creative
    Let's children customize their play area in seconds
    Turns rolling a toy vehicle into a more interesting and realistic
    driving adventure
    Frees children from artificial boundaries created by fixed tracks and
    pre-printed play tables and play mats
    Ease of application allows for infinite creative expression
    Allows for creation of realistic or fantasy cityscapes
    Creates infrastructure for integration of most popular building &
    construction toys
    Can be used on walls and furniture to create decorative accents
Safe
    Quick release formula leaves no adhesive residue
    Tears easily; no scissors or sharp implements required
    Non-toxic
Cost-effective
    Costs pennies per foot vs. wooden and plastic alternatives
        Estimated Road Play retail cost = $0.43 per foot
        Estimated wooden track retail cost = $6.08 per foot
        Estimated plastic track retail cost = $3.33 per foot
        Road Play is up to 90% less expensive
```

What is claimed is:

1. Material for creating a play environment for a play figure comprising:
non-scar, quick-release, adhesive material including an adhesive and a substrate;
portions of said material two-dimensionally simulating structures coordinated to interface with at least one three-dimensional play figure;
said material including a microsphere adhesive;
structured for substantial adherence to, and for non-scar quick-release from, domestic flooring, walls and furniture; and
including 10 micron to 80 micron microspheres and binder applied to the substrate with the microspheres predominantly oriented toward the substrate.

2. The material of claim 1 wherein the microspheres have an approximately 30 micron average diameter.

3. The material of claim 1 wherein the peel adhesion of the adhesive is approximately 8 ounces per inch to steel after a ten minute wet-out period.

4. The material of claim 1 wherein the adhesive is applied to the substrate by a transfer-coat process.

5. The material of claim 1 wherein the substrate includes fibrous paper.

6. The material of claim 1 wherein the substrate includes a clay coated surface.

7. The material of claim 1 wherein the substrate includes a primer.

8. The material of claim 1 wherein the material is wound on an approximately 1-3 inch diameter core.

9. The material of claim 1 wherein the material is of approximately 3 inch width.

10. The material of claim 1 wherein the material comprises a roll.

11. The material of claim 1 wherein the adhesive includes a high performance microsphere acrylic adhesive.

12. The material of claim 1 wherein the substrate includes approximately 70# paper of approximately 3.5-4.2 mil thickness.

13. The material of claim 1 wherein the adhesive is of approximately 0.5-0.7 mil thickness.

14. The material of claim 12 wherein the adhesive is of approximately 0.5-0.7 mil thickness.

15. A method for creating an adhesive material for use as a play environment for a play figure, comprising:
transfer-coating a high performance microsphere acrylic adhesive to a substrate to form an adhesive play material, the play material structured for easy tearing or cutting and for adhesion to and non-scar, quick release from domestic flooring, walls and furniture; and
decorating the material to two-dimensionally simulate a play environment for a three-dimensional toy.

16. The method of claim 15 that includes winding approximately 3-inch wide material upon an approximately 1.5 inch diameter core.

17. The method of claim 15 wherein the adhesive material has a thickness of approximately 4 to 5 mil, including an adhesive of approximately 0.5 to 0.7 mil thickness.

18. The method of claim 15 wherein the substrate includes fibrous paper with a clay coat primer.

19. The material of claim 1 including a substrate having adhesive along one portion, no adhesive along a second portion, and a score line in between, permitting folding a non-adhesive portion up to create a playscape.

20. The method of claim 15 including folding a portion of the substrate upwards upon use.
